(19) United States
(12) Patent Application Publication
(10) Pub. No.: US 2026/0237654 A1
(43) Pub. Date: Aug. 13, 2026

(54) PROCESSES FOR PRODUCING COMPOSITE MATERIALS

(71) Applicant: Anaphite Limited, Bristol (GB)

(72) Inventors: Sam Burrow, Bristol (GB); Elena Mogort-Valls, Bristol (GB); Conor Brady, Bristol (GB)

(21) Appl. No.: 19/154,129

(22) PCT Filed: Feb. 7, 2024
(86) PCT No.: PCT/GB2024/050342

§ 371 Date: Aug. 6, 2025

(30) Foreign Application Priority Data
Feb. 7, 2023 (GB) 2301741.1

(51) Int. Cl. H01M 4/525; H01M 4/02; H01M 4/04; H01M 4/131; H01M 4/36; H01M 4/505; H01M 4/62; H01M 10/0525

(52) U.S. Cl. CPC H01M 4/525; H01M 4/0404; H01M 4/131; H01M 4/364; H01M 4/505; H01M 4/623; H01M 4/625; H01M 10/0525; H01M 2004/028

(57) ABSTRACT

The present invention relates to composite materials and processes for forming said composite materials. The invention also relates to composites obtained by the processes described herein.

The present invention relates to composite materials and processes for forming said composite materials. Such composites may be fabricated into electrode films. The invention also relates to composites obtained by the processes described herein.

### BACKGROUND

Traditional batteries, including lithium (Li) ion batteries, comprise an anode, a separator material with an electrolyte medium, and a cathode. The anode electrode of most commercially available Li ion batteries is a copper foil coated with a mixture of graphite powder and a polymer blend such as polyvinylidene difluoride (PVDF). The cathode generally comprises a mixture of lithium transition metal oxides, PVDF and carbon black coated onto an aluminum foil.

Li-ion batteries require two electrodes to function; a cathode to store lithium when the cell is discharged (or in a low-energy state) and an anode to store lithium when/as the cell is charged. The two electrodes are separated by a porous separator, and the movement of lithium in a liquid electrolyte from the anode to the cathode is concurrent with a flow of electrons to deliver the battery's power to external circuits. The reverse occurs on charging of the battery.

For commercial batteries, particulate anode and cathode materials are used, due to ease of manufacture and the necessity of pores within the electrode to facilitate electrolyte ingress to facilitate local transfer of lithium ions. These ‘active material’ particles are usually coated onto sheet metal ‘current collectors’ to support the active materials and to provide long-range electron transfer from the battery terminals to the whole battery. These current collector sheets are then arranged in spirals or stacks depending on the format of the battery, e.g. cylindrical, prismatic, or pouch.

To attach the particles to a current collector, a binder is usually required. Such a binder will generally be required to not inhibit transfer of lithium ions to the surface of active electrode particles, while also facilitating cohesion of the active materials to each other and to any conductive additives, while enabling homogeneous adhesion of the mixture to a current collector.

There is not absolute freedom when choosing a binder material. The electrochemical nature of the battery means that any chemical components need to pass certain requirements for reactivity with the electrochemical system, in order to prevent capacity degradation of the cell over time. A well-known binder that best fits all the above requirements is polyvinylidene fluoride (PVDF). It is very commonly used throughout cell manufacturing facilities and academia. NMP (N-methyl-2-pyrrolidone) is normally used as the solvent to dissolve PVDF and form an electrode coating slurry. The electrode coating slurry typically contains PVDF, an active material and a conductive material. Upon coating the slurry onto a current collector, the NMP is evaporated, resulting in the adhesion of the mixture to the current collector. This process of coating and evaporation occurs continuously in industrial-scale cell manufacturing plants.

However, NMP is toxic, environmentally hazardous, and expensive. Manufacturing systems to use, evaporate, and recycle NMP form a significant proportion of the cell manufacturing costs (10-15%). Processes utilising NMP must be kept efficient to reduce its impact.

So far, manufacturers have been willing to make the sacrifice of cost to use NMP, for the benefits yielded when using PVDF as a binder. Reduction of NMP from coated slurries is a major driver for cell manufacturers-especially as the worldwide need for batteries expands exponentially as humanity makes the transition to green energy.

However, reducing NMP in cathode coating processes leads to an increase in the viscosity of the slurry. This in turn reduces the optionality for engineers wishing to incorporate high surface area carbon materials, which typically need low viscosity systems (e.g. <1 Pa·s) for adequate mixing with particulate cathode materials. There is a need for processes which facilitate mixing of carbon additives in dispersing solvents at low viscosity while also potentially reducing the amount of NMP used in cathode coating processes.

Incorporation of high surface area conductive carbon materials into electrodes is desirable due to their favourable electronic properties. However, a potential disadvantage of known methods of making conductive carbon containing electrode composites is that separation of the component solids can occur if the carbons are not properly dispersed, which is likely when using standard mixing techniques. This can lead to uneven distribution of the components in the composite, affecting the electrical performance.

The present invention was devised with the foregoing in mind.

### SUMMARY OF THE INVENTION

In a first aspect there is provided a process for fabricating a composite comprising an electrode active material, a polymeric binder and a conductive material, wherein the process comprises:
i. providing a first dispersion comprising a dispersing solvent and a polymeric binder dissolved therein;
ii. providing an antisolvent in which the polymeric binder is substantially insoluble;
   wherein at least one of the first dispersion and the antisolvent comprises an active material dispersed therein and at least one of the first dispersion and the antisolvent comprises a conductive material dispersed therein;
   wherein:
      the active material is present in an amount of from 80 to 99.5 wt. %;
      the conductive material is present in an amount of from 0.01 to 15 wt. %;
      the polymeric binder material is present in an amount of from 0.01 to 15 wt. %;
      based upon the total weight of the active material, conductive material and polymeric binder;
iii. contacting the first dispersion with the antisolvent to form a suspension mixture, wherein the volume ratio of the dispersing solvent to the antisolvent is from 1:1 to 1:10;
   wherein contacting the first dispersion with the antisolvent results in the precipitation of the binder in the presence of the active material and conductive material to form a composite.

In another aspect there is provided a composite comprising:
i) a battery active material in an amount of from 80 to 99.5 wt. %
ii) a polymeric binder in an amount of 0.01 to 15 wt. %
iii) a conductive material in an amount of 0.01 to 15 wt. %
based upon the total weight of the active material, conductive material and polymeric binder.

In another aspect, there is provided a composite obtained by, obtainable by, or directly obtained by the process defined herein.

In another aspect there is provided a composite slurry comprising a slurry solvent and a composite as defined herein dispersed within the slurry solvent, wherein the composite is present in the slurry solvent in an amount of at least 60 wt. % solids.

In another aspect there is provided the use of a composite slurry as defined herein, as an electrode coating slurry.

In another aspect there is provided an electrode comprising a composite as defined herein. Suitably, the composite is in the form of a film (i.e. an electrode film) coated onto a current collector.

In another aspect, there is provided a battery comprising an electrode as defined herein. Suitably, the battery is a lithium ion battery.

### Processes of the Present Invention

The present invention provides a process for fabricating a composite comprising an electrode active material, a polymeric binder and a conductive material, the process being as defined herein. The process is typically performed under low viscosity conditions, allowing the incorporation of high surface area carbon materials (e.g. graphene, carbon nanotubes).

In the processes of the present invention, an intimate composite comprising a binder, active material and conductive material is formed within a suspension. The suspension comprises the composite dispersed in a mixture of the dispersing solvent and antisolvent.

Suitably, the active material is present in an amount of from 85 to 99.5 wt. %, more suitably from 90 to 99 wt. %, or most suitably from 94 to 98.5 wt. %, based upon the total weight of the active material, conductive material and polymeric binder.

Suitably, the polymeric binder material is present in an amount of from 0.1 to 10 wt. %, more suitably from 0.5 to 6 wt. %, most suitably from 1.0 to 2.5 wt. %, based upon the total weight of the active material, conductive material and polymeric binder.

Suitably, the conductive material is present in an amount of from 0.05 to 10 wt. %, more suitably from 0.1 to 6 wt. %, most suitably from 1.0 to 2.5 wt. %, based upon the total weight of the active material, conductive material and polymeric binder.

Suitably, the concentration of the polymeric binder in the dispersing solvent is from 0.001% to 10 wt. %, more suitably from 0.01 to 5 wt. %, or 0.02 to 1 wt. %.

Suitably, the volume ratio of the dispersing solvent to the antisolvent is from 1:1 to 1:5, more suitably from 1:1 to 1:4. More suitably, the volume ratio of the dispersing solvent to the antisolvent is from 1:1.5 to 1:3.

Suitably, there is an excess of antisolvent relative to the dispersing solvent.

In the context of the present invention, the dispersing solvent is a solvent in which the binder is at least partially soluble in at 25° C. and 1 atm pressure. Suitably, the dispersing solvent is a solvent in which the binder is substantially soluble in at 25° C. and 1 atm pressure.

The dispersing solvent may be selected from NMP, DMSO, Cyrene or a combination thereof. Suitably, the dispersing solvent is NMP or DMSO. Most suitably, the dispersing solvent is NMP.

The antisolvent is a solvent in which the binder is substantially insoluble (i.e. at least 1000 mass part of the solvent is required to dissolve 1 mass part of solute at standard operating temperatures (e.g. 25° C. and 1 atm pressure). Suitably, the active material and conductive material are also substantially insoluble in the antisolvent.

The antisolvent may comprise one or more of methanol, water, acetone or a mixture thereof. Suitably, the antisolvent is selected from methanol or a blend of water and acetone.

Suitably, the antisolvent comprises no more than 75 wt. % water. For example, if a blend of acetone and water is to be used as an antisolvent, it may comprise at least 25 wt. % of acetone.

The blend of water and acetone may comprise from 10 to 75% water. Suitably, the blend of water and acetone may comprise from 30 to 70% water. Most suitably, the blend of water and acetone may comprise from 40 to 60% water.

Suitably, the viscosity of the first dispersion is less than or equal than 1 Pa·s prior to contact with the antisolvent.

Suitably, the viscosity of the suspension mixture is less than or equal to 1 Pa·s following addition of the antisolvent to the first dispersion.

Suitably, the particle size of the active material prior to addition of the antisolvent has a d90 between 1 μm and 40 μm. More suitably, the d90 may be between 10 μm and 30 um.

A wide range of particle sizes of the conductive material may be utilised, for example prior to addition of the antisolvent, the conductive material may have a d90 between 0.005 μm and 10 μm.

### Further Processing of Suspension Mixture

Suitably, once the composite is formed within the suspension, the process further comprises removing a portion of the dispersing solvent and/or antisolvent.

In certain embodiments, the process further comprises removing a substantially all of the antisolvent from the suspension. In such embodiments, the process may also comprise removing at least a portion of the dispersing solvent from the suspension.

In certain embodiments, the process further comprises removing at least a portion of the dispersing solvent from the suspension.

In some embodiments, the process further comprises drying the suspension mixture, thereby removing substantially all of the dispersing solvent and antisolvent to provide a dried composite. Following removal of the dispersing solvent and antisolvent, the dried composite may be in the form of a powder or particulate material.

The composite may suitably be dried. The drying may be achieved through heating, for example in a vacuum oven. In certain embodiments, substantially all of the dispersing solvent and antisolvent may be removed during the drying step. The dried composite may be processed into an electrode film (e.g. by coating onto a current collector), or may be reformulated into a composite slurry as described herein.

Suitably, the dried composite has a d90 particle size of from 10 to 5000 microns. More suitably, the composite has a d90 particle size of from 30 to 500 microns.

Suitably, the dispersing solvent and the antisolvent may be removed by a combination of different methods. The dispersing solvent and the antisolvent may be removed by filtration and/or decantation. The dispersing solvent and the antisolvent may also be removed by drying.

In some embodiments, substantially all of the antisolvent is removed, and a portion of the dispersing solvent remains, to provide a composite slurry.

The composite may be dried and then redispersed in a slurry solvent to form a composite slurry.

The process may also comprise filtering the composite to remove any non-composited materials, or materials with a particle size less than 10 microns.

### Formation of Composite Slurries

In certain embodiments, the composite formed in the suspension mixture may be incorporated into a composite slurry. The composite slurry suitably comprises the composite as defined herein in an amount of at least 60 wt. % solids, dispersed within a slurry solvent. Suitably, the binder material within the composite is at least partially soluble within the slurry solvent under the conditions required for coating (for example at room temperature and pressure).

The slurry solvent may be selected from NMP, Cyrene, ethylene carbonate, dimethyl carbonate, diethyl carbonate, propylene carbonate, DMF, or any solvent suitable for coating or extruding PVDF. Suitably, the slurry solvent is any one of the dispersing solvents described herein. Most suitably, the slurry solvent is NMP.

In certain embodiments, the suspension mixture comprising the composite can be reformulated to provide a composite slurry as defined herein. For example, where the active material comprises NMC, the suspension can be formulated into a composite slurry by removing substantially all of the antisolvent and optionally a portion of the dispersing solvent, to provide a composite slurry comprising the composite in an amount of at least 60 wt. % solids dispersed within the dispersing solvent. In such embodiments, the dispersing solvent also acts as the slurry solvent.

In other embodiments, if the suspension mixture is dried to provide a dried composite, then the dried composite powder may then be redispersed in a slurry solvent to form a composite slurry.

Suitably, where the active material substantially comprises a lithium transition metal oxide, following reformulation of the suspension mixture, or dried composite, into a composite slurry, the concentration of composite in the composite slurry is between 60 wt % solids and 99.9 wt % solids. More suitably, the concentration of composite in the formed composite slurry is between 60 wt % solids and 90 wt % solids. Most suitably the concentration of composite in the formed composite slurry is between 70 wt % solids and 85 wt % solids.

### Electrode Film Components

The composites of the present invention may be used to fabricate electrode films, particularly cathode films. As described herein, the composites comprise an active material, a binder and a conductive material. These materials, together with any further additives, can be collectively defined as electrode film components.

### Active Material

The active material in the electrode film of a battery is required to store and release cations (typically lithium ions). The active material in the electrode film or composites of the invention may be any suitable active material known in the art. The choice of active material will suitably depend on whether the electrode film is to be used in an anode or a cathode.

In a preferred embodiment of the invention, the active material is a cathode active material.

The active material is capable of being intercalated by, reacted with, or alloying with ions in a reversible electrochemical reaction. The ions may be selected from one or more of lithium, sodium, potassium, aluminum, magnesium, calcium, beryllium, lead, or nickel ions. Suitably, the ions are lithium ions.

A reversible electrochemical reaction may permit solid-state coupling and decoupling with ions, with an associated electron transfer to balance charges, where at least 40% of the ions are returnable from the active material in the opposing electrochemical reaction.

The active material may be lithium-active or sodium active material.

The active material may be selected from one or more of the following:
oxides, nitrides, carbides, sulfides, phosphides, and selenides of Silicon, Germanium, Antimony, Tin, Lead, Bismuth, Zinc, Aluminium, Titanium, Iron, Nickel, Manganese, Cobalt, or Cadmium, and their mixtures, or lithium-containing composites;
Lithium transition metal phosphates, e.g. lithium nickel phosphate, lithium cobalt nickel phosphate, lithium iron phosphate and lithium mixed-transition-metal phosphates;
lithium titanate, lithium manganate, lithium aluminate, lithium-containing titanium oxide; and
lithium transition metal oxides, such as:
   NMC (lithium nickel manganese cobalt oxide) and its stoichiometric variants, e.g. 910, 811, 622, 532, 111;
   NCA (Lithium nickel cobalt aluminium oxide) and its stoichiometric variants.

Suitably, the active material is selected from:
LTO (lithium titanates);
NMC (Lithium nickel manganese cobalt oxides);
NCA (Lithium nickel cobalt aluminium oxide);
LFP (lithium iron phosphate); or
Silicon.

More suitably, the active material is selected from LTO (lithium titanates) or NMC (Lithium nickel manganese cobalt oxides), such as NMC 811, NMC 910, NMC 622, NMC 532 or NMC 111, preferably NMC 811 or NMC 622.

Most suitably, the active material is NMC (lithium nickel manganese cobalt oxide). The NMC may be NMC 811, NMC 910, NMC 622, NMC 532 or NMC 111, suitably NMC 811 or NMC 622.

### Binder Materials

The binder material of a battery is present to primarily adhere the electrode film to a substrate such as a current collector. The binder materials utilised in the present invention are polymeric, and may be a flexible polymer.

Suitably, the polymeric binder comprises one or more of polyvinylidene fluoride (PVDF), poly(vinylidene fluoride-co-hexafluoropropylene) (PVDF-HFP), polyacrylic acid (PAA) and alkali metal salts thereof, modified polyacrylic acid (mPAA) and alkali metal salts thereof, methyl cellulose, carboxymethylcellulose (CMC), modified carboxymethylcellulose (mCMC), sodium carboxymethylcellulose (Na-CMC), polyvinylalcohol (PVA), alginates and alkali metal salts thereof, styrene-butadiene rubber (SBR), polyimide, polyethylene glycol (PEO), CMC/SBR mixtures, PAI (e.g. Torlon® Al-10), chitosan, chitosan sulfate ethylamide glycinamide (CSEG), polyvinylpyrrolidone (PVP), ammonium polyphosphate (APP), sulfonated polyether ether ketone with pendant lithiated fluorinated sulfonic groups (SPEEK-FSA-Li), Lithiated poly(perfluoroalkylsulfonyl)imide (PFSILi) ionene(s), poly(3,4-ethylenedioxythiophene) polystyrene sulfonate (PEDOT: PSS) doped further as appropriate, poly(9,9-dioctylfluorene-co-fluorenone-co-methylbenzoic acid) (PFFOMB), and poly(9,9-dioctylfluorene-co-fluorenone) (PFFO).

Most suitably, the polymeric binder is PVDF.

### Conductive Material

The conductive material (also known as a conductive additive) plays an important role in the electrochemical performance of lithium ion batteries. Such materials construct a conductive percolation network to increase and keep the electronic conductivity of electrode, impacting the rate at which the battery can charge and discharge, as well as the voltage drop associated with the charge and discharge. In addition, conductive additives may play a role in absorbing and retaining electrolyte, ultimately helping to maintain an intimate contact between the lithium ions and active materials.

The conducting material may comprise one or more of a two-dimensional layered material or a carbon-based conductive additive. Preferably, the conductive material comprises a conductive carbon material.

Suitable carbon-based conductive additives include carbon black, acetylene black, ketjen black, graphite, carbon fibre, carbon nanotubes and graphene, and other hard carbons. Graphene (i.e. pristine graphene) can be considered to be a conductive carbon material and a 2D layered material.

Suitable two-dimensional (2D) layered materials include graphene-based materials and inorganic layered materials.

Exemplary two-dimensional (2D) layered materials include:
graphene, graphene oxide, reduced graphene oxide, functionalised graphene, partially oxidised graphene (i.e. graphene with an oxygen content less than 15% that has not been reduced from graphene oxide or preferably graphene with an oxygen content less than 10 atom % that has not been reduced from graphene oxide);
metal oxide nanosheets which are composed of sheets of edge/corner sharing MO₆ octahedra, (where M is a transition metal, and O is oxygen), where the sheets are separated by alkali metal cations, protons, water, solvent or any combination thereof;
metal double hydroxides which are composed of octahedral hydroxide layers of divalent and trivalent metal cations, where charge is balanced with anions between the layers, represented by the general formula M²⁺₁₋ₓM³⁺ₓ(OH)₂Aⁿ⁻_{x/n}·mH₂O (where M²⁺=Mg²⁺, Fe²⁺, Co²⁺, Ni²⁺, Zn²⁺, etc.; M³⁺=Al³⁺, Fe³⁺, Co³⁺, etc.; and A=(CO₃)²⁻, Cl⁻, (NO₃)⁻, (ClO₄)⁻, etc.);
Phosphorenes (black phosphorus).
2D Chalcogenides:
hexagonal boron nitride (hBN), fluorographene, boron carbon nitride (BCN), SiC, Si2BN, silicene, germanene, stanene, borophene, graphyne, plumbene;
transition metal dichalcogenides with the general stoichiometry MX₂, where M is a transition metal atom and X is a chalcogen atom, (e.g. MoS₂, WS₂, MoTe₂, MoSe₂, WSe₂ etc.);
any other layered 2D material consisting of less than 4 elements in a compound, less than 40 atoms in the primitive cell, covalently bonded in-plane and held out-of-plane by weak intermolecular forces;
Layered Semiconductors, e.g. GaSe, GaTe, InSe, Bi₂Se₃, etc;
2D Oxides; for example, MnO₂, WO₃, TiO₂, MoO₃, V₂O₅, TaO₃, RuO₂, NaNbO₃, α-Fe₂O₃, Nb₂O₅, CO₃V₂O₈, Na_{1.08}V₃O₈, etc.
Layered Cu Oxides.
Perovskite-type e.g. Methylammonium lead halide (CH₃NH₃PbI₃), Cesium lead halides (CsPbX₃), Bi₄Ti₃O₁₂, Ca₂Ta₂TiO₁₀, etc.
Hydroxides, e.g. Ni(OH)₂, Eu(OH)₂, ZnAl-layered double hydroxide (LDH).
MXenes: Sc₂C(OH)₂, Sc₂CO₂, Ti₂CO₂, Titanium Carbide (Ti₃C₂).

Suitably, the 2D layered material is selected from graphene, partially oxidised graphene, (i.e. graphene with an oxygen content less than 15 atom %, or more preferably graphene with an oxygen content less than 10 atom % that has not been reduced from graphene oxide), halogenated graphene, hexagonal boron nitride (hBN), 2D metal oxides, 2D metal hydroxides, and transition metal dichalcogenides (e.g. MoS₂, WS₂, MoTe₂, MoSe₂). Surprisingly and advantageously, the present invention does not require any functionalisation of the 2D materials in order to form composites. Suitably, the 2D material is selected from graphene which has had less than 15% of its atoms covalently modified, or more preferably, graphene which has had less than 10% of its atoms covalently modified.

Suitably, the 2D material is selected from hBN, graphene or a transition metal dichalcogenide. Suitably, the 2D material is graphene (i.e. pristine graphene) or graphene with an oxygen content less than 15 atom %. Suitably, the 2D material is graphene with a FWHM Raman peak of less than 60 cm⁻¹.

In certain preferred embodiments of the invention, the conductive material comprises one or more conductive carbon materials, for example carbon black, acetylene black, ketjen black, graphite, carbon fibre, carbon nanotubes and graphene (e.g. pristine graphene), and other hard carbons. Preferably, the conductive material comprises one or more of pristine graphene, carbon black, or carbon nanotubes. More preferably, the conductive material comprises one or more of pristine graphene, carbon black, or carbon nanotubes.

In certain embodiments, the conductive material comprises a combination of carbon black and at least one of pristine graphene or carbon nanotubes.

It will be appreciated that certain conductive materials can have smaller loadings than others. For example, if the conductive material comprises only carbon black, then the conductive material may be present in an amount of at least 0.3 wt. %. However, if for example the conductive material comprises only graphene, then a loading of at least 0.01 wt. %, or 0.1 wt. % may be present.

### Dispersing Solvents

In preferred embodiments, the binders of the invention are fully dissolved in the dispersing solvent, prior to the formation of a composite.

Suitably, the dispersing solvent is a solvent with a boiling point above 150° C.

The dispersing solvent may be selected from any suitable solvent described herein. The preferred use of one solvent over another is dependent on the solubility of the binders within the dispersing solvent, conducting materials, and active materials used in each specific example.

Suitably, the dispersing solvent is selected from Cyrene (Dihydrolevoglucosenone); DMSO (dimethylsulfoxide); NMP; butyl lactate; dimethyl isosorbide; triacetin; DMF; 1,2-dichlorobenzene; benzonitrile; pyridine; triethyl citrate; THF, cyclohexanone; cyclopentanone; olefins including pentane, hexane, cyclohexane, heptane, cyclooctane; ethyl acetate; ethyl lactate; furfural; eugenol; isoeugenol; levulinic acid; chloroform; 1,2-dischloromethane; toluene; methyl-t-butyl ether; methyl ethyl ketone; trichloroethylene; xylene; IPA; Water; Acetone; Methanol.

In preferred embodiments, the dispersing solvent is selected from NMP, DMSO, Cyrene or mixtures thereof. Most suitably, the dispersing solvent is NMP.

### Antisolvents

The addition of antisolvent to the dispersing solvent will cause the precipitation of binder from the dispersing solvent. The precipitation of the binder causes the binder particles to act as a flocculant which binds the active material and conductive material together. Thus, the addition of an antisolvent results in the flocculation of the binder, active and conductive materials to form a composite in which the components are bound together. An advantage of applying binder flocculation by antisolvent over other methods is relatively quick immobilisation, where the components within the composite might not have time for segregation.

Suitable antisolvents for a binder material will depend upon the solubility profile of the binder to be used. The binder will typically be substantially insoluble in the antisolvent.

Suitably, the antisolvent is or comprises an aqueous soluble solvent (including water). More suitably, the antisolvent comprises one or more of methanol, water, acetone or a mixture thereof.

Suitably, if the binder is PVDF, then water alone is not used to precipitate the binder. Suitably, the antisolvent comprises no more than 75 wt. % water.

Suitably, the antisolvent is selected from methanol or a mixture of acetone and water. The ratio of water to acetone may be from 0.25:1 to 4:1, more suitably from 0.5:1 to 2:1, or most suitably from 0.75:1 to 1.25:1.

In a particular embodiment, the dispersing solvent is NMP and the antisolvent is selected from methanol or a mixture of acetone and water (e.g. a 0.25:1 to 4:1, a 0.5:1 to 2:1 or a 0.75:1 to 1.25:1 ratio of water to acetone).

### Mixing of Binder, Active and Conductive Materials

Suitably, in the process of the invention, the battery active material is added in an amount of from 85 to 99.5 wt. % based on the total weight of the electrode components. More suitably, the battery active material is present in an amount of from 90 to 99 wt. % based, on the total weight of the electrode components. Most suitably, the battery active material is present in an amount of from 94 to 98.5 wt. %, based on the total weight of the electrode components.

Suitably, in the process of the invention, the conductive material is added in an amount of 0.05 to 10 wt. %, based on the total weight of the electrode components. More suitably, the conductive material is present in an amount of from 0.1 to 6 wt. % based, on the total weight of the electrode components. Most suitably, the conductive material is present in an amount of 1.0 to 2.5 wt. %, based on the total weight of the electrode components.

Suitably, in the process of the invention, the binder is added in an amount of 0.1 to 10 wt. %, based on the total weight of the electrode components. More suitably, the binder is present in an amount of from 0.5 to 6 wt. % based, on the total weight of the electrode components. Most suitably, the binder is present in an amount of 1.0 to 2.5 wt. %, based on the total weight of the electrode components.

The process of the invention converts smaller sized individual materials (e.g. binder, conductive material, and active material particles) into larger sized composite materials. For example, the average particle size of the active material prior to precipitation of the binder will be less than 20 microns, which will typically increase to over 200 microns following formation of the composite comprising the binder, conductive material, and active material particles.

Suitably, substantially all of the electrode components added to the first dispersion will be comprised within the final composite material. However, should any of the individual components remain in a non-composited form, they may be removed from the suspension mixture, e.g. by filtration.

Suitably, the active material and conductive material are both present in the first dispersion prior to the formation of a composite by the addition of the antisolvent. Thus, the first dispersion suitably comprises the dispersing solvent, with the polymeric binder dissolved therein, and the active material and conductive material dispersed therein.

Suitably, the components are thoroughly mixed in the solvent in which they are present, i.e. the antisolvent or the first dispersion, to achieve a homogenous distribution of the components.

Suitably, the components in the first dispersion and the antisolvent will typically be mixed thoroughly to ensure uniform dispersion of the active and conducting material in the formed composite.

Following contacting of the antisolvent with the first dispersion, the suspension will also be thoroughly mixed.

The mixing will suitably be performed throughout the process of the invention to maintain a uniform distribution of the components.

The mixing may comprise one or more of sonication, stirring, planetary mixing, shear mixing, or any of the methods disclosed herein. Suitably, the mixing comprises shear mixing and/or planetary mixing.

The electrode components can be mixed in the dispersing solvent using standard mixing techniques known in the art, for example sonication, stirring, high shear homogenisation, blending, high pressure homogenisation. The binder may be dissolved within the dispersing solvent before or after the addition of the remaining components.

Suitably, the conductive material, active material and any further additives are added to the first dispersion or antisolvent. Dispersion of the mixture in the respective solvent to form a homogenous slurry may suitably be performed after the addition of each component to the dispersing solvent or antisolvent.

The mixing may be performed continuously throughout the process. Thus, the slurry may be subjected to shear energy (such as mixing, sonication etc.) throughout the process of the invention.

### Composites of the Present Invention

The invention also provides composites as defined herein.

Precipitation of the binder from the dispersing solvent in the presence of an active material and a conductive material will result in the formation of aggregating particles of solid binder in the slurry. Since the aggregating particles are formed in the presence of the remaining electrode components, such as the active and conductive material, the binder solidifies in close contact with these components, adhering them together. This results in the formation of an intimate composite of the electrode components.

### Composites of the Present Invention

As discussed above, the present invention provides a composite comprising:
i) a battery active material in an amount of from 80 to 99.5 wt. %
ii) a polymeric binder in an amount of 0.01 to 15 wt. %
iii) a conductive material in an amount of 0.01 to 15 wt. %.

Suitably, the binder, active and conductive materials are selected from any of the materials described herein.

Suitably, the composites of the invention comprise a battery active material in an amount of from 85 to 99.5 wt. %, more suitably from 85 to 99 wt. % or most suitably from 94 to 98.5 wt. %.

Suitably, the composites of the invention comprise a conductive material in an amount of from 0.1 to 10 wt. %, more suitably, from 0.5 to 6 wt. %, or most suitably 1.0 to 2.5 wt. %.

Suitably, the composites of the invention comprise a binder material in an amount of from 0.1 to 10 wt. %, more suitably, from 0.5 to 6 wt. %, or most suitably 1.0 to 2.5 wt. %.

The composites formed in the present invention will typically be in the form of a solid cohesive agglomerated particles, for example a powder or particulate material.

Suitably, the dried composite has a d90 particle size of from 10 to 5000 microns. More suitably, the composite has a d90 particle size of from 30 to 500 microns.

### Composite Slurries of the Present Invention

The composite materials formed by the invention can be mixed into solvents such as NMP to form slurries with relatively high solids content, while still incorporating well-mixed carbons with high surface area. Providing slurries with high solids content means that less NMP may be needed during wet mixing and electrode coating and drying processes.

The invention therefore also provides a composite slurry comprising a slurry solvent and a composite, as defined herein, dispersed within the slurry solvent, wherein the composite is present in an amount of at least 60 wt. % solids, and the polymeric binder present in the composite is soluble in the slurry solvent.

Suitably, the concentration of composite in the formed composite slurry is between 60 wt % solids and 90 wt % solids. Most suitably the concentration of composite in the formed composite slurry is between 70 wt % solids and 85 wt % solids.

Suitably, the slurry solvent may be any of the dispersing solvents described herein. Most suitably, the slurry solvent is NMP.

Suitably, the composite particles within the composite slurry have a d90 which is smaller than the dried composite powder.

Suitably, the viscosity of a composite slurry of the present invention is greater than 1 Pa·s. More suitably, the viscosity of the composite slurry is at least 6 Pa·s, for example between 6 and 10 Pa·s. Such slurries may be suitable for mass production of coated electrodes, e.g. using slot die coating. Alternative embodiments of the composite slurry may have a substantially higher viscosity, e.g. over 10, or over 20 Pa·s. Higher viscosity composite slurries may be coated to surfaces using extrusion techniques, e.g. twin-screw mixing.

In some embodiments, a composite slurry as defined herein may be used to coat current collectors in the formation of battery electrodes.

A particular advantage of the present invention is the broad utility of the formed composite in different coating scenarios. While other efforts have been focused on making entirely dry powders, the option to use a broad range of liquid-based deposition process (for example, slot die, reverse comma bar, extrusion) is advantageous for its compatibility with the existing infrastructure already invested in battery factories around the world.

The present invention also provides the use of a composite slurry as defined herein as an electrode coating slurry.

A composite slurry as defined herein may be utilised in wet mixing techniques. Thus, there is provided the use of a composite slurry as defined herein in a wet mixing process.

In an embodiment, a process for wet mixing comprises:
a) forming or providing a composite slurry comprising a composite and a slurry solvent, as defined herein;
b) applying the composite slurry to a substrate;
c) following application of the composite slurry to the substrate, removing the slurry solvent to adhere the composite to the surface of the substrate.

The substrate may be a current collector, e.g. an aluminium, copper, nickel, titanium or steel current collector.

The process of wet mixing may suitably be a process for forming an electrode.

The composite slurry mixture may be applied to the substrate by any conventional wet coating process, preferably selected from the group consisting of screen printing, coating using a roll coater, a blade coater, a slit coater (slot-die coater), a comma bar coater, a curtain coater, a wire coater, a sprayer, a foam applicator, and a brush coater.

### Exemplary Embodiment

An exemplary way to prepare an electrode film, and subsequently a lithium ion battery, is provided below:
1. NMC 811 (an active material) is mixed with suspended graphene sheets (conductive material) in NMP (dispersing solvent).
2. PVDF (a binder) is dissolved in NMP (dispersing solvent) and added to the mixture, and shear energy is applied to the mixture to thoroughly mix all components.
3. An antisolvent is mixed thoroughly into the mixture to generate a solid composite product. The antisolvent is a blend of acetone and water (75:25 acetone: water).
4. The solid product is filtered and dried to yield a composite product.
5. The composite product is formed into a composite slurry mixing in NMP at a solids content of 61 wt. %.
6. The composite slurry is formed into an electrode film by coating onto a current collector, drying, and calendaring.
7. The current collector is assembled with a separator, counter electrode, and electrolyte in a sealed container to function as a Li-ion battery.

It will be appreciated that for each of the above steps, the relevant active material, conductive material, dispersing solvent, binder, antisolvent and further solid materials could be replaced with any appropriate material disclosed herein. The relevant active material, conductive material, dispersing solvent, binder, antisolvent and further solid materials may also be present in any of the amounts described herein.

Similarly, the further processing steps to form an electrode film could be replaced with any suitable process to convert a film into an electrode film and further assemble the film into a battery.

### Batteries Utilising Composites of the Invention

Following the formation of an electrode comprising an electrode film coated onto a current collector. The method of the invention suitably further comprises assembling a battery comprising the current collector coated with the electrode film. Assembling a battery suitably comprises assembling the coated current collector with a separator, counter electrode and electrolyte in a sealed container. The counter electrode may be an anode or a cathode as appropriate.

The counter electrode used in a battery may also have been prepared according to the process of the present invention.

### Particular Embodiments of the Invention

In an embodiment, the process comprises
i. providing a first dispersion comprising a dispersing solvent and a polymeric binder dissolved therein; wherein the dispersing solvent further comprises an active material and a conductive material dispersed therein; wherein the active material, conductive material and polymeric binder material are present in the amounts defined herein;
ii. providing an antisolvent in which the binder is substantially insoluble;
iii. contacting the dispersing solvent with the antisolvent to form the composite as described herein, wherein the ratio of dispersing solvent to antisolvent is as defined herein.

In a particular embodiment, the conductive material comprises a conductive carbon material, and the polymeric binder is PVDF, and:
a. The dispersing solvent is selected from DMSO, NMP, or Cyrene or mixtures thereof; and
b. The antisolvent comprises methanol, dichloromethane, acetone, water, ethanol, or mixtures thereof.

In a particular embodiment, the conducting material comprises a conductive carbon material, and the polymeric binder is PVDF, and:
a. The dispersing solvent is NMP; and
b. The antisolvent comprises methanol, acetone, water or a mixture thereof.

In a particular embodiment:
a. the conductive material comprises a conductive carbon material;
b. the polymeric binder is PVDF;
c. the active material is selected from LTO (lithium titanates), NMC (Lithium nickel manganese cobalt oxides), NCA (Lithium nickel cobalt aluminium oxide), LFP (lithium iron phosphate) or silicon (e.g. 300 mesh silicon chunks);
d. The dispersing solvent is selected from DMSO, NMP, or Cyrene or mixtures thereof; and
e. The antisolvent comprises methanol, dichloromethane, acetone, water, ethanol, or mixtures thereof.

In a particular embodiment:
a. the conductive material comprises a conductive carbon material selected from one or more of carbon black, carbon nanotubes and pristine graphene;
b. the polymeric binder is PVDF;
c. the active material is selected from LTO, NMC, NCA, LFP or silicon:
d. The dispersing solvent is NMP; and
e. The antisolvent comprises one or more of methanol, acetone, water or a mixture thereof.

In a particular embodiment:
a. the conductive material comprises a conductive carbon material selected from one or more of carbon black, carbon nanotubes and pristine graphene;
b. the polymeric binder is PVDF;
c. the active material is selected from LTO or NMC:
d. The dispersing solvent is NMP; and
e. The antisolvent comprises one or more of methanol, acetone, water or a mixture thereof.

In an embodiment of the processes of the invention, and the composites of the invention, the active material, conductive material and polymeric binder are present in the following relative amounts:

| active material | conductive material | polymeric binder |
|---|---|---|
| 85-99.5 wt. % | 0.1-10 wt. % | 0.1-10% wt. % |

In an embodiment of the processes of the invention, and the composites of the invention, the active material, conductive material and polymeric binder are present in the following relative amounts:

| active material | conductive material | polymeric binder |
|---|---|---|
| 90-99% wt. % | 0.5-6% wt. % | 0.5-6% wt. % |

In an embodiment of the processes of the invention, and the composites of the invention, the active material, conductive material and polymeric binder are present in the following relative amounts:

| active material | conductive material | polymeric binder |
|---|---|---|
| 94-98.5 wt. % | 1-2.5 wt. % | 1-2.5 wt. % |

In an embodiment of the processes of the invention, and the composites of the invention, the viscosity of the first dispersion, comprising all of the active material, conductive material and polymeric binder, measured immediately before the addition of the antisolvent or any additional materials, is less than or equal to 1 Pa·s.

In an embodiment of the processes of the invention, and the composites of the invention, the viscosity composite slurry comprising the composite of the invention, measured immediately before coating onto a substrate, is greater than 1 Pa·s.

### BRIEF DESCRIPTION OF THE DRAWINGS

Embodiments of the invention are further described hereinafter with reference to the accompanying drawings, in which:

FIG. 1 shows UV/Vis absorbance (solid bars), and extrapolated theoretical supernatant graphene concentration (striped bars) for composite component samples, with their respective settled solids volume reduction relative to the solution (solid dots). Inset 8× and 10× represents dilution required to collect UV-Vis data. Striped bars have corrected for this dilution. Graphene concentration is labelled as ‘carbon’. Number labels above the solid bars (UV/Vis absorbance) refer to the precise number measured of supernatant samples in a cuvette with 1 cm path length.

FIG. 2 shows example images of solids components after 1 hour of settling. IDs are as follows, left>right: No Binder; No LTO; No Graphene; All components present (control).

### DETAILED DESCRIPTION

The present invention provides a process for efficiently fabricating a dry composite comprising an electrode active material, a polymeric binder and a conductive material, where the conductive material has been mixed in a low viscosity process (≤1 Pa·s). Such powders may be mixed with solvents to make an electrode coating slurry (i.e. a composite slurry) of high viscosity and low NMP content.

By virtue of the process of the invention, the components of the composites of the invention are strongly bound together within the composite. This results in composites which do not break down into their component parts when dispersed in solvents such as NMP.

### Definitions

The term “slurry” in the context of the invention is intended to mean a mixture comprising a liquid (e.g. dispersing solvent) and undissolved (active material and conductive material) and/or partially/fully dissolved solid materials. Generally, the term “slurry” may be used interchangeably with the term “dispersion” and also “suspension”. However, in the context of the present invention, the three terms are used to indicate the composition of slurries obtained different stages of the process:
a. The “first dispersion” relates to a slurry mixture of the dispersing solvent, the dissolved binder, and optionally further comprises an active material and/or a conductive material dispersed within the dispersing solvent.
b. The “suspension” or “suspension mixture” relates to the mixture of antisolvent, dispersing solvent, and formed composite present following the precipitation of the binder in the presence of the active material and conductive material to form the composite.
c. The “composite slurry” relates to a mixture comprising a solvent in which the binder material is at least partially soluble, and the formed composite. Suitably, the composite slurry does not comprise any solvent in which the binder material is insoluble.

Without wishing to be bound by theory, it is thought that components of a composite of the invention (i.e. active, binder and conductive material) are attracted to each other if in the presence of polymers like PVDF as the polymers are precipitating.

Flocculation is an advantageous step to include in a process as it permits the utilization of large amounts of solvent without the need for significant liquid evaporation or otherwise physical means of obtaining a product, which instead may be filtered by coarse filtration or sedimentation. Given that it is often difficult to obtain a good dispersion of 2D materials in solvents, flocculation of a product will permit recycling of the large volume of solvent likely needed when scaling up the production of 2D-particulate material composites.

The interaction between the active material and the conductive material (in the presence of the precipitating polymer particles) results in an increase in the particle size of the composite relative to the particulate material. This arises due to the formation of ‘secondary particles’ (aggregates of composite material) in the dispersing solvent. Thus, the use of antisolvent precipitation is advantageous over simple high shear mixing of particulate materials and 2D materials, because larger, bound particles can be formed. These larger particles are beneficial for further processing steps, as larger particles are known to have more predictable properties than nano-sized particles (e.g. nano-sized particles can be difficult to stabilise).

In the methods described herein, the addition of an antisolvent to the binder in the dispersing solvent will induce the conductive material and the particulate material to flocculate and form a composite material. The binder will be included in an amount sufficient to induce aggregation. Without wishing to be bound by theory, it is thought that inducing flocculation in this manner results in improved interaction between the 2D material and the particulate. This will often result in an increase in particle size due to the interaction between 2D and particulate materials. This results in a more efficient process for making composites of 2D materials than previously demonstrated in the prior art. Before addition of the antisolvent, the particle size within dispersion is expected to be the size at which it was made, e.g. 1 um particles and higher. Generally, only small, unflocculated, particles (e.g. less than 10 um) are observed with the microscope before addition of the antisolvent. However, larger particles may be visible depending on the preparation method used to form the dispersion.

Flocculated products are advantageous because solvents can be recycled efficiently, as the formed flocculated material is easily separated from the dispersion mixture during flocculation. This also means that a relatively large amount of solvent can be used for the dispersion of the 2D material, which reduces the risk of aggregation of the 2D material with itself, and ensures a homogeneous mixture of the composite.

The term ‘two-dimensional material” (2D material) may mean a compound in a form which is so thin that it may exhibit different properties than the same compound when in bulk. Typically, two-dimensional inorganic compounds are in a form which is single- or few layers thick, i.e. up to 10 layers thick. A two-dimensional crystal of a layered material (e.g. an inorganic compound or graphene) is a single or few layered particles of that material.

It will be understood by a skilled person that a 2D material may be defined as a layered material with an in-plane modulus significantly higher than the shear modulus between the layers. Such materials include but not are restricted to, graphene, WS₂, MoS₂ and hexagonal boron nitride. Typically, a 2D material will comprise from 1-10 molecular layers.

2D materials do exhibit thicknesses, however the dimensions of those thicknesses are significantly lower than the widths and lengths of these materials, thus the origin of the name ‘2D materials’.

The term ‘few-layered particle’ means a particle which is so thin that may exhibit different properties than the same compound when in bulk. Not all of the properties of the compound will differ between a few-layered particle and a bulk compound, but one or more properties are likely to be different. A more convenient definition would be that the term ‘few layered’ refers to a crystal that is from 2 to 9 atomic or molecular layers thick in cross-section (e.g. 2 to 5 layers thick). Crystals of graphene, for example, which have more than 9 molecular layers (i.e. 10 atomic layers; 3.5 nm) generally exhibit properties more similar to graphite than to graphene. An atomic or molecular layer is the minimum thickness chemically possible for the compound. In the case of boron-nitride one molecular layer is a single atom thick. In the case of the transition metal dichalcogenides (e.g. MoS₂ and WS₂), a molecular layer is three atoms thick (one transition metal atom and two chalcogen atoms). Thus, few-layer crystals of 2D materials are generally less than 50 nm thick, depending on the compound and are preferably less than 20 nm thick, e.g. less than 10 or 5 nm thick. However, for current top-down production methods, such as ball-milling, shear mixing or liquid phase exfoliation, the final dispersion consists of distribution of thicknesses rather than the single defined one.

The term ‘inorganic layered compound’ refers to any compound made up of two or more elements which forms layered structures in which the bonding between atoms within the same layer is stronger than the bonding between atoms in different layers. Many examples of inorganic layered compounds have covalent bonds between the atoms within the layers but van der Waals bonding between the layers. The term ‘inorganic layered compound’ is not intended to encompass graphene.

Many inorganic compounds exist in a number of allotropic forms, some of which are layered and some of which are not. For example boron nitride can exist in a layered graphite-like structure or as a diamond-like structure in which the boron and nitrogen atoms are tetrahedral orientated.

Examples of layered inorganic compounds to which the present invention can be applied include: hexagonal boron nitride (h-BN), bismuth strontium calcium copper oxide (BSCCO), transition metal dichalcogenides (TMDCs), Sb₂Te₃, Bi₂Te₃ and MnO₂.

TMDCs are structured such that each layer of the compound consists of three atomic planes: a layer of transition metal atoms (for example Mo, Ta, W etc.) sandwiched between two layers of chalcogen atoms (for example S, Se or Te). Thus in one embodiment, the TMDC is a compound of one or more of Mo, Ta and W with one or more of S, Se and Te. There is strong covalent bonding between the atoms within each layer of the transition metal chalcogenide and predominantly weak Van der Waals bonding between adjacent layers. Exemplary TMDCs include NbSe₂, WS₂, MoS₂, TaS₂, PtTe₂, VTe₂.

A layer of graphene consists of a sheet of sp²-hybridized carbon atoms. Each carbon atom is covalently bonded to three neighbouring carbon atoms to form a ‘honeycomb’ network of tessellated hexagons. Carbon nanostructures which have more than 10 graphene layers (i.e. 10 atomic layers; 3.5 nm) generally exhibit properties more similar to graphite than to mono-layer graphene. Thus, throughout this specification, the term graphene is intended to mean a carbon nanostructure with up to 10 graphene layers (for example, where 90% of the graphene flakes have a thickness of 2 to 7 layers or where 90% of the graphene flakes have a thickness of 3 to 10 layers). Graphene is the ‘ultimate’ 2D material as it is defined by having one carbon atom thickness layer/sheet, which is a structural unit of graphite.

The level of graphene defects in a composite can be assessed using Raman spectroscopy in a manner similar to L. G. Cancado et al. 2011, “Quantifying Defects in Graphene via Raman Spectroscopy at Different Excitation Energies”, Nano Letters, which is incorporated herein by reference. The ratio of the intensity of the observed D peak Raman intensity, referred to as I (D), to the G peak Raman intensity, referred to as I (G), indicates the amount of defects present within the graphene. This is referred to as the I (D)/I (G) ratio. The distance between defects is a measure of the amount of disorder. Given the distance between defects is greater than approximately 4 nm; the lower the I (D)/I (G) ratio, the greater the distance between defects, thus, the amount of disorder is lower. In addition to this, the full width at half maximum (FWHM) of D, G, 2D (2D is also referred to as G′), and D′ peaks can be used to evaluate the level of disorder as discussed in E. H. Martins Ferreira et al. 2010, “Evolution of the Raman spectra from single-, few-, and many-layer graphene with increasing disorder”, PHYSICAL REVIEW B. If FWHM of D, G, 2D (2D is also referred to as G′), and D′ Raman peaks at a laser excitation wavelength of 514.5 nm (2.41 eV), are reaching values lower than 20 cm-1, 20 cm-1, 35 cm-1, and 10 cm-1 respectively, then the distance between zero dimensional point-like defects is expected to be greater than approximately 4 nm.

The composites formed by the method of the present invention which contain graphene may have an I (D)/I (G) ratio of less than 0.75, less than 0.6 or preferably less than 0.5, at a laser excitation wavelength of 532 nm (2.33 eV). Thus, the composites formed by the method of the present invention may have an I(D)/I(G) ratio of from 0.01 to 0.75, 0.02 to 0.65 or 0.04 to 0.55, at a laser excitation wavelength of 532 nm (2.33 eV). Given the distance between defects is greater than approximately 4 nm and a laser excitation wavelength of 532 nm (2.33 eV); an I(D)/I(G) ratio less than 1 indicates that the defects are greater than 9.5 nm apart.

It is also possible to assess the nature of the graphene defects using Raman spectroscopy. In general, defects in graphene are considered to be anything that breaks the symmetry of the infinite carbon hexagonal lattice. This therefore includes edges, vacancies and changes in carbon-hybridization (e.g. sp² into sp³). An sp³ defect is due to an additional atom being present out-of-plane of the graphene layer resulting in an sp³ hybridized carbon atom or atoms. A vacancy defect is due to one or more missing atoms of a 2D material layer. An edge defect is due to a graphene sheet not being infinitely large and therefore having an edge.

Partially oxidised graphene and pristine graphene can be distinguished from graphene oxide, functionalised graphene and reduced graphene oxide using Raman spectroscopy, as discussed herein. Graphene oxide and functionalised graphene contain high amounts of sp³ defects. Reduced graphene oxide is formed from the reduction of graphene oxide with reducing agent or temperature treatment. Reduced graphene oxide also includes a large amount of vacancy defects, as a result of the removal of oxygen to leave holes in the hexagonal lattice. Thus, graphene oxide and reduced graphene oxide typically have an I (D)/I (G) ratio of above 0.8 or FWHM of D, G, 2D (in some literature called G′) peaks values higher than 70, 70, 150 cm⁻¹ respectively. Conversely, partially oxidised graphene oxide has fewer oxygen atoms compared to graphene oxide but has not undergone harsh reduction processes like reduced graphene oxide. Thus, more of the hexagonal structure is maintained, meaning fewer sp³ and vacancy defects. The number of defects can be assessed by measuring the I (D)/I (G) ratio or FWHM of peaks as discussed above.

The presence of sp³ defects and vacancy defects can have a detrimental impact on the usefulness of the final composite. Thus, it is desirable for the number of sp³ and/or vacancy defects to be minimised.

The ratio of the intensity of the Raman D peak, referred to as I (D), to the Raman D′ peak, referred to as I (D′), signifies the type of defects present in the sample. This is referred to as the I (D)/I (D′) ratio. A ratio less than approximately 3.5, at a laser excitation wavelength of 514.5 nm (2.41 eV) indicates contributions from edge defects dominate. A ratio of approximately 7 indicates the presence of vacancy defects and a ratio of approximately 13 or more suggests sp³ defects.

The graphene composites of the present invention may have a FWHM-(G) (Full Width at Half Maximum of the graphene Raman G peak of a Raman spectra) of lower than 70 cm⁻¹ at a laser excitation wavelength of 514.5 nm (2.41 eV). Preferably, the FWHM-(G) will be lower than 60 cm⁻¹ at a laser excitation wavelength of 514.5 nm (2.41 eV). More preferably, the FWHM-G will be lower than 50 cm⁻¹ at a laser excitation wavelength of 514.5 nm (2.41 eV). Even more preferably, the FWHM-(G) will be lower than 40 cm⁻¹ at a laser excitation wavelength of 514.5 nm (2.41 eV). Most preferably, the FWHM-(G-) will be lower than 30 cm⁻¹ at a laser excitation wavelength of 514.5 nm (2.41 eV).

The graphene-containing composites of the present invention may have a FWHM-(2D) (Full Width at Half Maximum of the graphene Raman 2D peak) lower than 100 cm⁻¹ at a laser excitation wavelength of 514.5 nm (2.41 eV). Preferably, the FWHM-(2D) will be lower than 80 cm⁻¹ at a laser excitation wavelength of 514.5 nm (2.41 eV). More preferably, the FWHM-(2D) will be lower than 60 cm⁻¹ at a laser excitation wavelength of 514.5 nm (2.41 eV). Even more preferably, the FWHM-(2D) will be lower than 50 cm⁻¹ at a laser excitation wavelength of 514.5 nm (2.41 eV). The graphene-containing composites of the present invention may have an I (D)/I (D′) ratio of from 0.01 to 7, 0.01 to 4.5, 0.01 to 3.5 or preferably from 0.1 to 3.45 at a laser excitation wavelength of 532 nm (2.33 eV). Thus, the composites of the present invention will preferably have minimal sp³ defects and more preferably minimal vacancy defects.

Graphene oxide typically comprises a weight percentage of oxygen of above 15 wt. %. In the scope of the present invention, the term “partially oxidised graphene” can be interpreted as a graphene oxide which only comprises oxygen in an amount of up to 15% of the total weight of the graphene, e.g. 5 to 15 wt. %. Typically, partially oxidised graphene would include oxygen in an amount of up to 10% of the total weight of the graphene. As discussed above, the term “pristine graphene” refers to graphene which has not been chemically modified.

The processes described within may be performed with graphene that is not substantially chemically modified, i.e. pristine graphene. Usually the quality of such graphene is achieved using liquid phase exfoliation method. However, some graphene production methods may introduce some degree of oxidation (below 15%), resulting in partially oxidised graphene, as a result of slight oxidation facilitating faster exfoliation. However, unlike previous work involving graphene oxide, this degree of oxidation does not necessarily increase the processability of the graphene, and preferably the partial degree of oxidation/the degree of defects is reduced to as low as possible to reduce the impact on the conductive properties of the final composite material.

A “graphene-based” material refers to a 2D layered material which comprises a hexagonal carbon skeleton, such as graphene, graphene oxide, reduced graphene oxide, functionalised graphene (e.g. fluorinated graphene). Thus, a material that is “not graphene based” refers to materials which could be termed as “inorganic layered compounds”. Thus, the term ‘inorganic compound’ refers to any compound made up of two or more elements which forms layered structures in which the bonding between atoms within the same layer is stronger than the bonding between atoms in different layers. Many examples of inorganic layered compounds have covalent bonds between the atoms within the layers but van der Waals bonding between the layers. The term ‘inorganic layered compound’ is not intended to encompass graphene or graphene derivatives.

Particular examples of non-graphene based layered inorganic compounds to which the present invention can be applied include:
Graphene-like materials, such as hexagonal boron nitride (h-BN), fluorographene, boron carbon nitride (BCN), SiC, Si2BN, silicene, germanene, stanene, borophene, graphyne, plumbene.
Phosphorenes (black phosphorus).
2D Chalcogenides:
Transition metal dichalcogenides (TMDCs) such as MoS₂, WS₂, MoSe₂, WSe₂.
Layered Semiconductors: GaSe, GaTe, InSe, Bi₂Se₃, etc.
2D Oxides: MnO₂, WO₃, TiO₂, MoO₃, V₂O₅, TaO₃, RuO₂, NaNbO₃, α-Fe₂O₃, Nb₂O₅, Co₃V₂O₈, Na_{1.08} V₃O₈, etc.
Layered Cu Oxides.
. Perovskite-type: Methylammonium lead halide (CH₃NH₃PbI₃), Cesium lead halides (CsPbX₃), Bi₄Ti₃O₁₂, Ca₂ Ta₂TiO₁₀, etc.
Hydroxides: Ni(OH)₂, Eu(OH)₂, ZnAl-layered double hydroxide (LDH).
MXenes: Sc₂C(OH)₂, Sc₂CO₂, Ti₂CO₂, Titanium Carbide (Ti₃C₂).

Graphene-like materials have their lattice structure arranged as honeycomb and the atoms are held by sp2 or sp3 hybridization.

Phosphorene's structure consists of sp3 hybridization of phosphorus atoms within a 2D plane. Defect-free phosphorene has nonzero band gap and high electron mobility.

Chalcogenides are materials containing one or more chalcogen elements (e.g. S, Se or Te) as a substantial constituent. TMDCs are structured such that each layer of the compound consists of three atomic planes: a layer of transition metal atoms (for example Mo, Ta, W) sandwiched between two layers of chalcogen atoms (for example S, Se or Te). Thus in one embodiment, the TMDC is a compound of one or more of Mo, Ta and W with one or more of S, Se and Te. There is strong covalent bonding between the atoms within each layer of the transition metal chalcogenide and predominantly weak Van der Waals bonding between adjacent layers. TMDC can be semiconducting, metallic, and insulating. For instance, semiconducting dichalcogenides are MoTe₂, WTe₂, ZrS₂, ZrSe₂, and metallic dichalcogenides include NbSe₂, NbS₂, TaS₂, TiS₂, NiSe₂.

2D oxide compounds are all constituted of stacked negatively charged slabs, corner- and/or edge-shared MO₆ (M=Ti, Nb, Mn, Ta, W) octahedral units, and alkali metal cations (K+, Rb+, Cs+) occupying the inter-layer space. A common feature of these layered oxides is their cation-exchange property involving interlayer alkali metal ions.

The general formula of M²⁺M³⁺(OH). Aⁿ⁻mH O (M²⁺=Mg²⁺, Fe²⁺, 1−x x 2 x/n 2 Co2+, Ni²⁺, Zn²⁺, etc.; M3+=Al³+, Fe3+, Co3+, etc.) is for layered double hydroxides (LDH). LDH consists of octahedral-brucite-like M (OH) 2 layers and charge-balancing anions (An−). the host layer [M²⁺₁₋ₓM³⁺ₓ(OH)₂]^{x+} is positively charged with a charge density determined by the molar fraction x (0.2≤x≤0.33) of M³⁺. In addition, a new family of layered rare-earth hydroxide [RE(OH)_{2.5x}H2O]·[Aⁿ⁻]_{0.5/n} (RE=Nd, Sm, Eu, Gd, Tb, Dy, Ho, Er, Tm, Yb, Lu, Y) was synthesized and characterized with positively charged layers of [RE³⁺(OH)_{2.5x}H2O]^{0.5+} and charge-balancing anions, Aⁿ⁻, (Cl, NO₃, etc.) sandwiched between the layers.

2D perovskites can be defined as (A′)ₘAₙ₋₁BₙX₃ₙ₊₁, where A′ is cation (m=1 or 2) which intercalates between the inorganic Aₙ₋₁BₙX₃ₙ₊₁ sheets (n-thickness of the inorganic layers).

Materials belonging to the MXene group are layered transition metal carbides and carbonitrides. The structure can be defined with the general formula of Mₙ₊₁XₙTₓ, where M stands for early transition metal, X stands for carbon and/or nitrogen and Tₓ stands for surface terminations (mostly ═O, —OH or —F), and usually n is between 1 and 4. MXenes exhibit high electric conductivity (10000-1500 Scm⁻¹) combined with hydrophilic surfaces that can be tuned with solvents. They are synthesized from ceramic precursor MAX phases by removing the single atomic layer “A” where M stands for Ti, Mo, W, Nb, Zr, Hf, V, Cr, Ta, Sc, A stands for Al, Si, and X stands for C, N.

TMDCs are structured such that each layer of the compound consists of three atomic planes: a layer of transition metal atoms (for example Mo, Ta, W) sandwiched between two layers of chalcogen atoms (for example S, Se or Te). Thus in one embodiment, the TMDC is a compound of one or more of Mo, Ta and W with one or more of S, Se and Te. There is strong covalent bonding between the atoms within each layer of the transition metal chalcogenide and predominantly weak Van der Waals bonding between adjacent layers. Exemplary TMDCs include NbSe₂, WS₂, MoS₂, TaS₂, PtTe₂ and VTe₂.

The term “substantially insoluble” in the context of the present invention means that at least 1000 mass parts of solvent is required to dissolve 1 mass part of solute at standard operating temperatures (e.g. 25° C. and 1 atm pressure). The term “insoluble”, in the context of the present invention means that greater than 10000 mass parts of solvent is required to dissolve 1 mass part of solute.

The term ‘viscosity’ in the context of the present invention refers to the dynamic viscosity measured a shear rate of 10 s⁻¹ at a temperature of 20° C.

Throughout the description and claims of this specification, the words “comprise” and “contain” and variations of them mean “including but not limited to”, and they are not intended to (and do not) exclude other moieties, additives, components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, compounds, chemical moieties or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

The reader's attention is directed to all papers and documents which are filed concurrently with or previous to this specification in connection with this application and which are open to public inspection with this specification, and the contents of all such papers and documents are incorporated herein by reference.

### EXAMPLES

### Example 1—Examining the Stability of Graphene in MeOH Vs NMP

### Background

Graphene flakes are known to be difficult to disperse in most solvents. The methods of the present invention provide methods to disperse graphene in graphene-loving solvents like NMP before forming a composite and performing solvent exchange activities to replace the NMP with another solvent that is easier to process with or remove.

This experiment directly probes the relative stability of graphene in an alcohol, methanol (MeOH), and in NMP (N-Methyl-2-pyrrolidone), by measuring the UV/Vis absorbance at 660 nm.

### Experimental

Graphene (G1 Sigma, Levidian) was added into either MeOH or NMP in a loading of 10 g/L. The mixtures were exposed to shear mixing at 10 k RPM using an IKA Ultra Terrax T25 high shear mixer, equipped with a 18 mm high shear mixing head. The solution was kept at room temperature (c.f. 20 degrees centigrade) with a water jacket during the shearing, to avoid heating and evaporation of the solvents. For measurement, shearing was paused, a 10 μL aliquot was removed, and diluted 300× in the respective solvent, before the UV-Vis absorbance was determined.

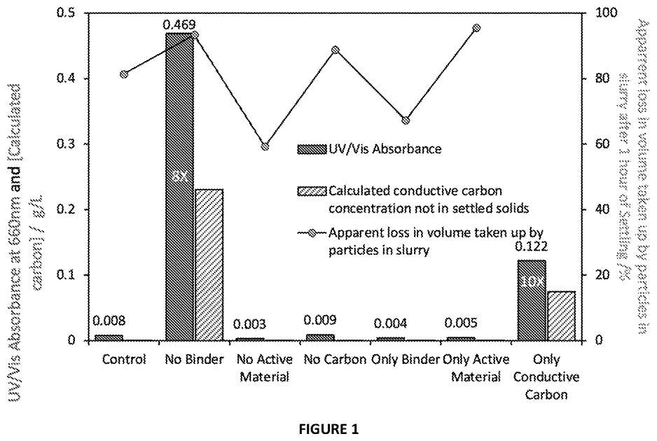

The data (shown in FIG. 1) showed that the dispersions with MeOH had around half the absorbance of the solutions with NMP. The lower absorbance is unlikely to be due to a lower concentration of graphene. UV-vis measurements are based on The Beer-Lambert law that states that the absorbance of a solution is directly proportional to the concentration of the absorbing species in the solution and the path length. Thus, the discrepancy between actual and UV-vis determined concentration can arise from the lack of homogeneous distribution of absorbing species in a given volume or their physical/chemical changes. For this instance, the discrepancy is likely to be graphene agglomerates/aggregates, consistent with known behaviours of relative graphene dispersibility in MeOH vs NMP. Absorbance data is provided in Table 1 below:

TABLE 1

| Dispersing | NMP | 4:1 (by volume) | MeOH |
|---|---|---|---|
| solvent | dispersion | MeOH:NMP mix | alone |
| UV/Vis | 1.2 | 0.8 | 0.5 |
| absorbance | | | |
| at 660 nm | | | |

### Example 2—Proof of PVDF Precipitation in PVDF Process, Via Deduction

### Background

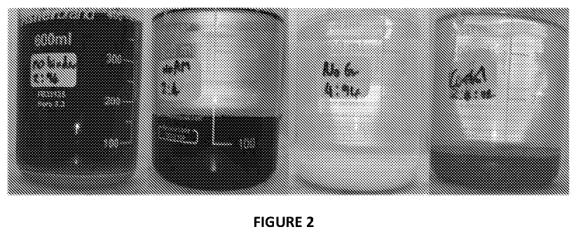

This experiment shows that 1) the binder is causing compositing, and 2) the binder is causing formation of discrete particulates in solution comprising graphene, the active material, and the binder. Recording the height of the settled solids is the method used to show that the particulates are physically attached, as physically attached particles of this type stack less efficiently than unattached particles. This height of settled solids is reported in % as ‘apparent loss in volume taken up by particles in slurry’, using the calculation 100*(height in vessel taken up by settled solids) divided by (height in vessel initial). With this calculation, a higher number implies the particles stack better, as this means higher ‘loss’ in volume occupied by the particles. Images illustrating settled particle layers is reported in FIG. 2. UV-vis transmittance at 660 nm, collected from liquid in the supernatant above the settled solids, is the method used to indicate ‘graphene concentration’. However, the relevance of UV-vis (reported in labels for each reading in the bar chart in FIG. 1) to the graphene concentration is dependent on the assumption that graphene concentration relates to UV-vis absorbance by the Beer-Lambert law, with an absorption coefficient of 16.3 ml mg⁻¹ cm⁻¹. This assumes only graphene is in the supernatant. However, the UV-vis reading still gives a strong indication of solids suspended in a liquid, e.g. solids not incorporated into the settled solids at the bottom of the vessel. The reported UV-vis from samples ‘No Binder’ and ‘Only graphene’, as reported in FIG. 1, were recorded from supernatants that were diluted eight times and ten times, respectively, due to the high absorbance of the supernatants for those samples. These dilutions were performed due to inaccurate readings being likely from extremely high absorbance samples. LTO and graphene are used as illustrative materials in this example as they are clearly distinguished by optical imagery, which can help make deductions of their behaviour trivial by optical analysis of suspensions. In FIG. 1, graphene is labelled as “carbon”.

### Experimental

Graphene pre-dispersed in NMP was obtained from Sixonia GmbH, and LTO in powder form from Targray (LTO-2S powder), and PVDF from Thermo Fisher, (product code 044080.A3). For this experiment, a nominal ratio of 2:4:94 of Graphene: PVDF: LTO needed to be mixed with further NMP as needed to yield a solids concentration of 125 g/L, and corresponding graphene concentration of 2.5 g/L. 80 ml of this mixture has a theoretical max solids of 10 g. A set of samples were created, omitting one or more components as indicated, but keeping everything else the same.

The mixture of solids was rapidly stirred in a beaker with magnetic stirring for 1 hour, whereupon there was a rapid addition of Methanol, in a 4:1 volumetric ratio MeOH:NMP, yielding 400 ml solution. This underwent further stirring for 15 m, before settling for 1 hour.

Images of the settled solution show the level of compositing and UV-Vis of supernatant indicate the degree of graphene (Gr) present. Results are detailed in FIG. 1, and in Table 2 below.

TABLE 2

| | | Apparent Gr in | |
|---|---|---|---|
| | | supernatant, derived | |
| | Apparent | from UV-Vis | |
| | loss in | absorbance of | |
| | volume | supernatant, | |
| | taken up by | reported as a % | |
| | particles | of the theoretical | |
| Sample | in slurry | concentration of 0.5 g/L | Reasoning |
| Control (all | 80% | ~0.01% | Binder has incorporated graphene with |
| components | | | the LTO to make three-component |
| present) | | | composite particles. The supernatant |
| | | | has a clear colour, implying all |
| | | | components are in the settled solids at |
| | | | the bottom of the beaker. The colour of |
| | | | the solids is homogeneously a dark grey |
| | | | colour. It is likely that the slurry volume |
| | | | reduction is not as much as ‘without Gr’ |
| | | | as immobilised high surface area |
| | | | graphene sheets are causing the |
| | | | composite particles to stack less |
| | | | efficiently. |
| No binder | 95% | ~50% | Absent binder, the LTO has settled to |
| (PVDF) | | | the bottom in a dense, slightly grey |
| | | | layer. The Gr level being below 100% |
| | | | may be due to some incorporation in the |
| | | | LTO, but is also likely due to the |
| | | | MeOH:NMP mix having poor graphene |
| | | | dispersibility, causing aggregation of |
| | | | graphene over the 1 hr settling period |
| | | | (see example 1). It's also possible that |
| | | | some LTO has remained suspended in |
| | | | solution and is interrupting the UV-Vis |
| | | | beam at 660 nm and causing an |
| | | | artificially lower absorbance reading. |
| No active | 60% | ~0.01% | Binder has incorporated graphene into a |
| material | | | two-component composite. The |
| (LTO) | | | supernatant appears clear. Volume |
| | | | reduction is likely less than the Control |
| | | | as LTO is more dense than Gr so will |
| | | | increase the compaction under gravity |
| | | | slightly. |
| No graphene | 90% | ~0.01% | Absent graphene, the LTO is able to |
| | | | stack a little better than the Control but |
| | | | cannot reach the volume reduction that |
| | | | it can achieve with no binder (95%) or |
| | | | with no binder and no graphene |
| | | | (97.5%). |
| Only binder | 65% | ~0.01% | Binder precipitates and forms a clear |
| | | | layer in the mixture to reach an apparent |
| | | | volume of 65%. Absent of LTO or Gr, |
| | | | the binder is not affected by gravity as |
| | | | much as when combined with either. |
| | | | Interestingly, the low density of the |
| | | | binder layer formed implies the |
| | | | precipitated binder formed by methods |
| | | | of the present invention has high surface |
| | | | area. |
| Only active | 97.5% | ~0.01% | Active material is not affected by |
| material | | | bonding to either binder or graphene so |
| (LTO) | | | is free to stack much more densely. |
| Only | N/A | ~16% | See example 1: the dispersibility of |
| graphene | | | graphene in NMP:MeOH mixes is not |
| | | | very high, which would reduce the signal |
| | | | seen by the UV-vis spectrometer. |

1. A process for fabricating a composite comprising an electrode active material, a polymeric binder and a conductive material, wherein the process comprises:
i. providing a first dispersion comprising a dispersing solvent and a polymeric binder dissolved therein;
ii. providing an antisolvent in which the polymeric binder is substantially insoluble;
wherein at least one of the first dispersion and the antisolvent comprises an active material dispersed therein and at least one of the first dispersion and the antisolvent comprises a conductive material dispersed therein;
wherein:
the active material is present in an amount of from 80 to 99.5 wt. %;
the conductive material is present in an amount of from 0.01 to 15 wt. %;
the polymeric binder material is present in an amount of from 0.01 to 15 wt. %;
based upon the total weight of the active material, conductive material and polymeric binder;
iii. contacting the first dispersion with the antisolvent to form a suspension mixture, wherein the volume ratio of the dispersing solvent to the antisolvent is from 1:1 to 1:10;
wherein contacting the first dispersion with the antisolvent results in the precipitation of the binder in the presence of the active material and conductive material to form a composite.

2. The process according to claim 1, wherein there is an excess of antisolvent relative to the dispersing solvent.

3. The process according to claim 1 or claim 2, wherein the volume ratio of the dispersing solvent to the antisolvent is from 1:1 to 1:5, e.g. 1:1 to 1:4;
optionally wherein the volume ratio of the dispersing solvent to the antisolvent is from 1:1.5 to 1:3.

4. The process according to any one of the preceding claims, wherein the dispersing solvent comprises a solvent selected from NMP, DMSO, Cyrene or a mixture thereof;
optionally wherein the dispersing solvent is NMP.

5. The process according to any one of the preceding claims, wherein the antisolvent comprises one or more of methanol, water, acetone or a mixture thereof;
optionally wherein the antisolvent comprises no more than 75 wt. % water.

6. The process according to any one of the preceding claims, wherein the active material is a cathode active material.

7. The process according to claim 6, wherein the cathode active material is selected from:
oxides, nitrides, carbides, sulfides, phosphides, and selenides of Silicon, Germanium, Antimony, Tin, Lead, Bismuth, Zinc, Aluminium, Titanium, Iron, Nickel, Manganese, Cobalt, or Cadmium, and their mixtures, or lithium-containing composites;
Lithium transition metal phosphates, e.g. lithium nickel phosphate, lithium cobalt nickel phosphate, lithium iron phosphate and lithium mixed-transition-metal phosphates;
lithium titanate, lithium manganate, lithium aluminate, lithium-containing titanium oxide; and
lithium transition metal oxides, such as:
NMC (lithium nickel manganese cobalt oxide) and its stoichiometric variants, e.g. 910, 811, 622, 532, 111;
NCA (Lithium nickel cobalt aluminium oxide) and its stoichiometric variants;
optionally wherein the cathode active material is selected from one or more of LTO, NMC, NCA, LFP, or silicon (e.g. 300 mesh silicon chunks);
further optionally wherein the cathode active material is NMC, for example NMC 910, NMC 811, NMC 622, NMC 532 or NMC 111.

8. The process according to any one of the preceding claims, wherein the polymeric binder is PVDF.

9. The process according to any one of the preceding claims, wherein the conductive material comprises a conductive carbon material.

10. The process according to any one of the preceding claims, wherein the conductive carbon material is selected from one or more of carbon black, acetylene black, ketjen black, graphite, carbon fibre, carbon nanotubes and graphene (e.g. pristine graphene), and other hard carbons.

11. The process according to any one of the preceding claims, wherein the conductive material comprises one or more of pristine graphene, carbon black, or carbon nanotubes.

12. The process according to any one of the preceding claims, further comprising drying the suspension mixture to provide a dried composite.

13. The process according to claim 12, wherein the dried composite is redispersed in a slurry solvent in an amount of at least 60 wt. % solids to provide a composite slurry, wherein the slurry solvent is selected from any one of the dispersing solvents defined in claim 4.

14. The process according to any one of the preceding claims, further comprising removing at least a portion of the dispersing solvent and the antisolvent from the suspension mixture.

15. The process according to claim 14, wherein substantially all of the antisolvent is removed, and a portion of the dispersing solvent is removed.

16. The process according to claim 15, wherein following removal of the at least a portion of the dispersing solvent and substantially all of the antisolvent, the composite is present in the dispersing solvent in an amount of at least 60 wt. % solids.

17. The process according to any one of the preceding claims, wherein the active material is present in an amount of from 85 to 99.5 wt. %, preferably from 90 to 99 wt. %, or more preferably from 94 to 98.5 wt. %.

18. The process according to any one of the preceding claims, wherein the binder is present in an amount of from 0.1 to 10 wt. %, preferably from 0.5 to 6 wt. %, more preferably from 1.0 to 2.5 wt. %.

19. The process according to any one of the preceding claims, wherein the conductive material is present in an amount of from 0.1 to 10 wt. %, preferably from 0.5 to 6 wt. %, more preferably from 1.0 to 2.5 wt. %.

20. A composite, obtained by, obtainable by or directly obtained by the process according to any one of claims 1 to 19.

21. A composite comprising:
i) a battery active material in an amount of from 80 to 99.5 wt. %
ii) a polymeric binder in an amount of 0.01 to 15 wt. %
iii) a conductive material in an amount of 0.01 to 15 wt. %
based upon the total weight of the active material, conductive material and polymeric binder.

22. A composite slurry comprising a composite according to claim 20 or 21, wherein the composite is dispersed within a slurry solvent in an amount of at least 60 wt. % solids, wherein the polymeric binder present in the composite is soluble in the slurry solvent.

23. A wet mixing process comprising:
a) providing a composite slurry according to claim 22;
b) applying the composite slurry to a substrate;
c) following application of the composite slurry to the substrate, removing the slurry solvent to adhere the composite to the surface of the substrate.

24. An electrode comprising a composite according to claim 20 or 21.

25. A battery comprising an electrode according to claim 24; optionally wherein the battery is a lithium ion battery.
